(19) United States
(12) Patent Application Publication
(10) Pub. No.: US 2016/0276117 A1
(43) Pub. Date: Sep. 22, 2016

(54) ELECTRIC TOOL

(71) Applicant: IZUMI PRODUCTS COMPANY, Matsumoto-shi (JP)

(72) Inventor: Hiroyuki YAJIMA, Matsumoto-shi (JP)

(73) Assignee: IZUMI PRODUCTS COMPANY, Matsumoto-shi (JP)

(21) Appl. No.: 15/060,021

(22) Filed: Mar. 3, 2016

(30) Foreign Application Priority Data
Mar. 20, 2015 (JP) 2015-057049

(51) Int. Cl. H01H 13/14

(52) U.S. Cl. CPC H01H 13/14; H01H 2221/052; H01H 2231/048; H01H 2223/04

(57) ABSTRACT

An electric tool capable of preventing unintentional driving from being performed is provided. An electric tool of the invention is an electric tool configured to be driven by electricity, and includes a switch knob configured to turn a driving power source ON by being pressed, wherein the switch knob is provided with a lock plate fixed so as to be slidable between a first position coming into abutment with a predetermined portion of a body portion of the electric tool and a second position not coming into abutment with the body portion when the switch knob is pressed.

### CROSS-REFERENCE TO RELATED APPLICATION

This application is based upon and claims the benefit of priority of the prior Japanese Patent Application No. P2015-057049, filed on Mar. 20, 2015, and the entire contents of which are incorporated herein by reference.

### FIELD

The present invention relates to an electric tool driven by electricity.

### BACKGROUND

Electric tools configured to perform a predetermined operation by being driven by electricity such as crimp tools for fixing crimp-type terminals to wires or cables, and cutting tools configured to cut wires, cables, and the like are known in the related art.

As an example, an electric tool 101 described in Patent Literature 1 is proposed (see FIG. 7). The electric tool disclosed in this publication is of a cordless type crimp tool provided with a demountably mountable battery 112 on a body portion 110, and is configured to fix crimp-type terminals to wires or cables by driving a hydraulic pump (not illustrated) with an electric motor (not illustrated) and hydraulically closing a distal end portion of a cap 116 while an operator is pressing a switch knob 114.

### CITATION LIST

### Patent Literature

PTL: JP-A-2013-169573

### SUMMARY OF INVENTION

### Technical Problem

The cordless-type electric tool disclosed in Patent Literature 1 may be stored or transported with a battery mounted in the body portion. At that time, if the switch knob is brought into a pressed state by contact or the like with the operator, an object, or the like, unintentional driving may result.

In view of such circumstances, it is an object of the invention to provide an electric tool configured to be capable of preventing unintentional driving.

### Solution to Problem

The problem described above is solved by solving means disclosed below as an embodiment.

A disclosed electric tool is an electric tool driven by electricity and includes a switch knob which turns a drive power source ON by being pressed, and the switch knob is provided with a lock plate fixed so as to be slidable between a first position at which the lock plate is allowed to come into abutment with a predetermined portion of a body portion of the electric tool and a second position at which the lock plate does not come into abutment with the body portion in response to a switching operation of the switch knob.

### Advantageous Effects

According to the invention, even though an operator or an object comes into contact with the switch knob unintentionally, the switch knob is restricted from being pressed, and thus prevention of unintentional driving is enabled.

### BRIEF DESCRIPTION OF THE DRAWINGS

FIG. 1 is a schematic view (perspective view) illustrating an example of an electric tool of an embodiment of the invention.

FIG. 2 is a schematic drawing (partial cross-sectional view) of a distal end portion of the electric tool illustrated in FIG. 1.

FIG. 3A is an enlarged view of a switch knob of the electric tool illustrated in FIG. 1 and a portion in the vicinity thereof in a state in which a lock plate is moved to a rear end portion (first position).

FIG. 3B is an enlarged view of the switch knob of the electric tool illustrated FIG. 1 and a portion in the vicinity thereof in a state in which the lock plate is moved to a distal end portion (second position).

FIG. 4A is a schematic view (perspective view) of an example of the switch knob and the lock plate of the electric tool illustrated in FIG. 1 in a state in which the lock plate is moved to the rear end portion (first position).

FIG. 4B is a schematic view (perspective view) of the switch knob of the electric tool illustrated in FIG. 1 and the lock plate in a state in which the lock plate is moved to a distal end portion (second position).

FIGS. 5A and 5B are schematic drawings of an example of the switch knob of the electric tool illustrated in FIG. 1.

FIGS. 6A and 6B are schematic drawings of an example of the lock plate of the electric tool illustrated in FIG. 1.

FIG. 7 is a schematic view of an example of an electric tool of an embodiment of the related art.

### DESCRIPTION OF THE EMBODIMENTS

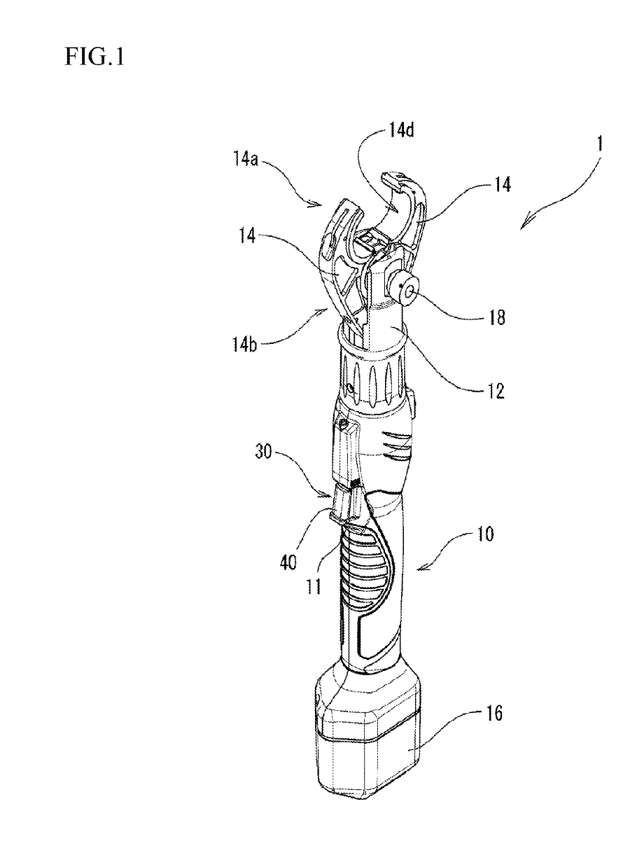

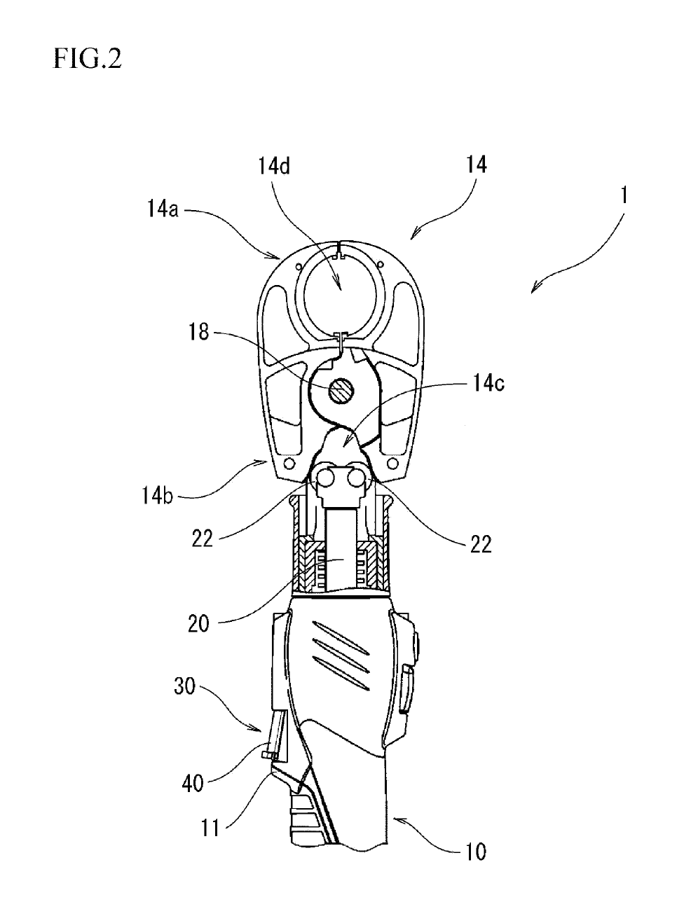

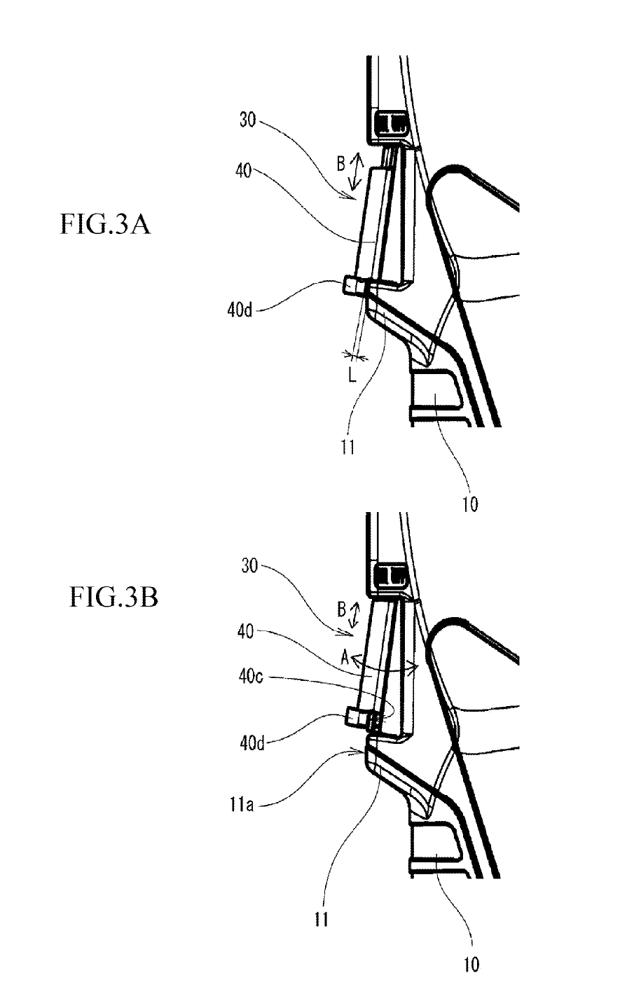

Referring now to the drawings, an embodiment of the invention will be described below in detail. FIG. 1 is a schematic view (perspective view) illustrating an example of an electric tool 1. FIG. 2 is a schematic drawing (partial cross-sectional view) of a distal end portion of the electric tool 1. FIGS. 3A and 3B are enlarged views of a switch knob 30 of the electric tool 1 (a state in which a lock plate 40 is engaged) and a portion in the vicinity thereof. Components having the same function are denoted by the same reference numerals throughout the drawings and repeated descriptions may be omitted for describing the embodiment.

The electric tool 1 according to the embodiment is a cordless type electric tool which allows an operator to operate by gripping with one hand as illustrated in FIG. 1 and FIG. 2. A cap at a distal end portion thereof is configured to be replaceable. For example, by providing a cap 14 for crimping at the distal end portion thereof, the electric tool can be used as a crimp tool configured to pressure-bond cables or the like and crimp-type terminals by crimping. In contrast, by providing a cap (not illustrated) having a cutter for cutting at the distal end portion thereof, the electric tool can be used as a cutting tool for cutting cables or the like. Hereinafter, a case where the electric tool 1 of the embodiment is a crimp tool will be described as an example.

The electric tool 1 includes a rod-shaped body portion 10 where the operator grips, a mounting portion 12 fixed to a distal end thereof, the cap 14 mounted on the mounting portion 12 so as to be replaceable, and a rechargeable and mountable-dismountable battery 16. As an example, the cap 14 is supported by the mounting portion 12 so as to be pivotable about a shank 18 as a center axis.

The body portion 10 includes an electric motor driven by a power source of the battery 16, a hydraulic cylinder driven by the electric motor, and a control unit configured to perform control such as driving provided in an interior thereof (none of them is illustrated).

An operation of the electric tool 1 having the configuration described above is as follows. A piston 20 of the hydraulic cylinder moves toward a distal end of the body portion 10 when the electric motor is driven. At this time, a roller 22 provided at a distal end of the piston 20 enters an opening 14c formed at a rear end portion 14b of the cap 14 so as to push out the opening 14c. Therefore, the rear end portion 14b acts in an opening direction, and a distal end portion 14a axially supported by the shank 18 acts in a closing direction. Therefore, by storing the cable or the like and the crimp-type terminal in a depressed portion 14d formed at the distal end portion 14a of the cap, an action of crimping the cable and the crimp-type terminal is achieved.

In the configuration of the present embodiment, the power source is supplied from the battery 16 and the electric motor is driven only while the switch knob 30 provided on the body portion 10 is being pressed. However, the invention is not limited thereto, and a configuration in which driving of the electric motor is started when the switch knob 30 is pressed and driving of the electric motor is stopped when the switch knob 30 is pressed again.

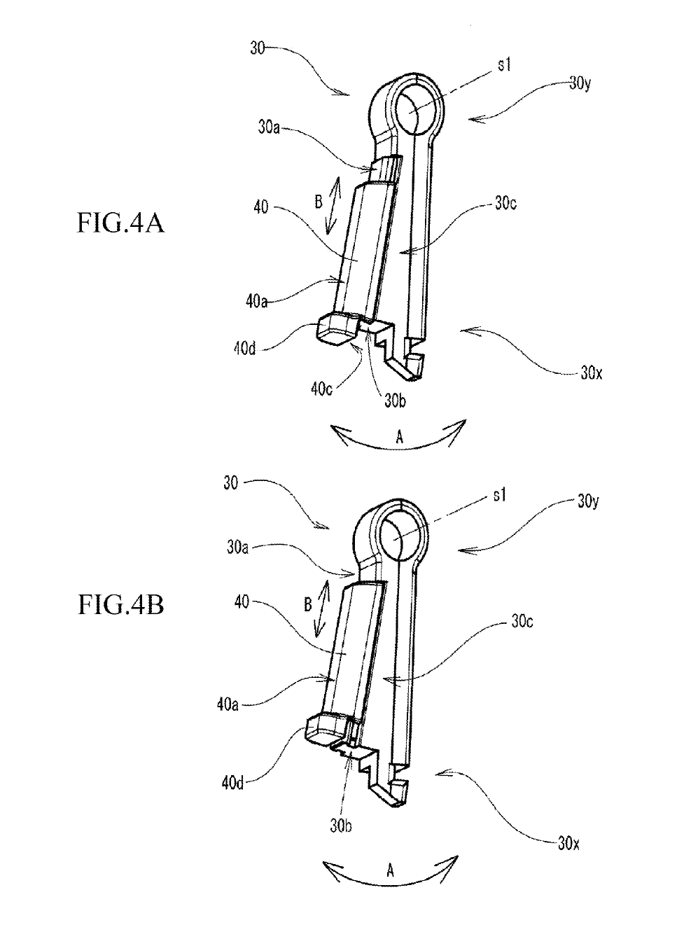

The switch knob 30 of the present embodiment will be described. The switch knob 30 is provided with a lock plate 40 fixed thereto so as to be capable of sliding movement. A schematic drawing (perspective view) in the state in which the lock plate 40 is fixed to the switch knob 30 is illustrated in FIGS. 4A and 4B. The switch knob 30 is fixed with one end side (distal end side) 30y axially supported by the body portion 10 so as to allow other end side (rear end side) 30x to pivot in an arcuate shape (in a direction indicated by an arrow A) about an axis s1 as a center axis.

The lock plate 40 is disposed on the switch knob 30 on a plane of an upper surface (referred to as a “first surface”) 30a orthogonal to the direction of pivotal movement (the direction indicated by the arrow A). As a modification, a configuration in which the lock plate 40 is disposed on a plane of a side surface (referred to as a “second surface”) 30c is also applicable (not illustrated).

The lock plate 40 is configured to be slidable between a first position (position illustrated in FIGS. 3A and 4A/locked position) at which the lock plate 40 is allowed to come into abutment with a predetermined portion of the body portion 10 when the switch knob 30 is pressed and a second position (position illustrated in FIGS. 3B and 4B/unlocked position) at which the lock plate 40 is not allowed to come into contact with any part of the body portion 10. More specifically, in the body portion 10, the predetermined portion of the body portion 10 corresponds to a projecting portion 11 which extends upright so as to extend along an end surface (rear end surface) 30b of one end side (rear end side) 30x of the switch knob 30.

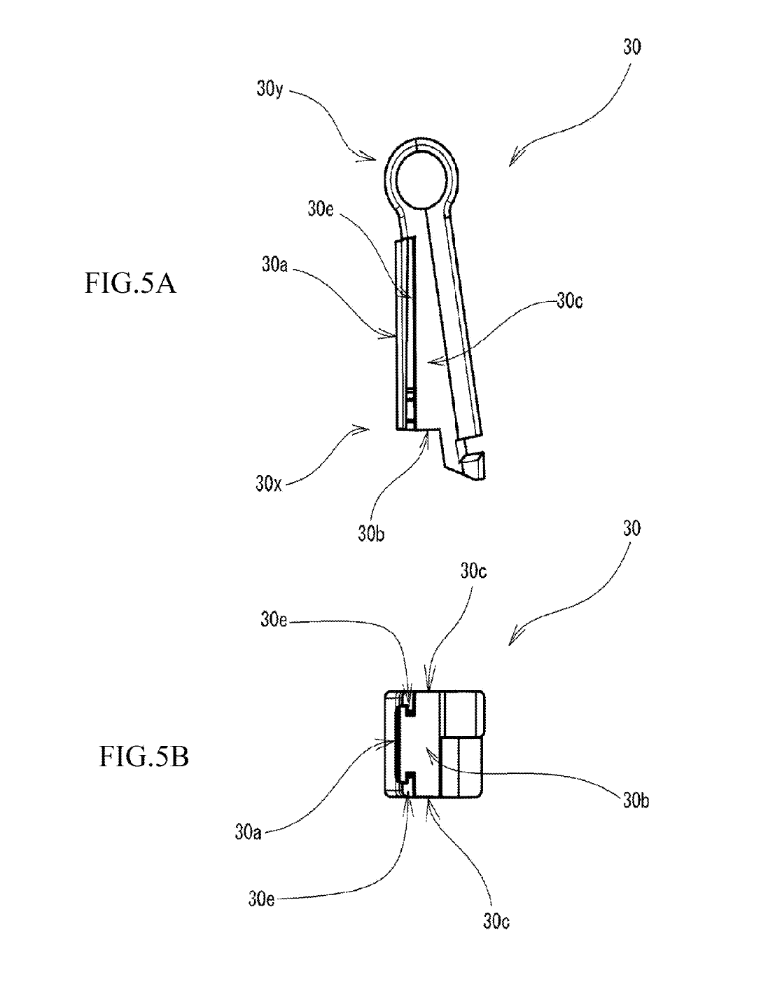

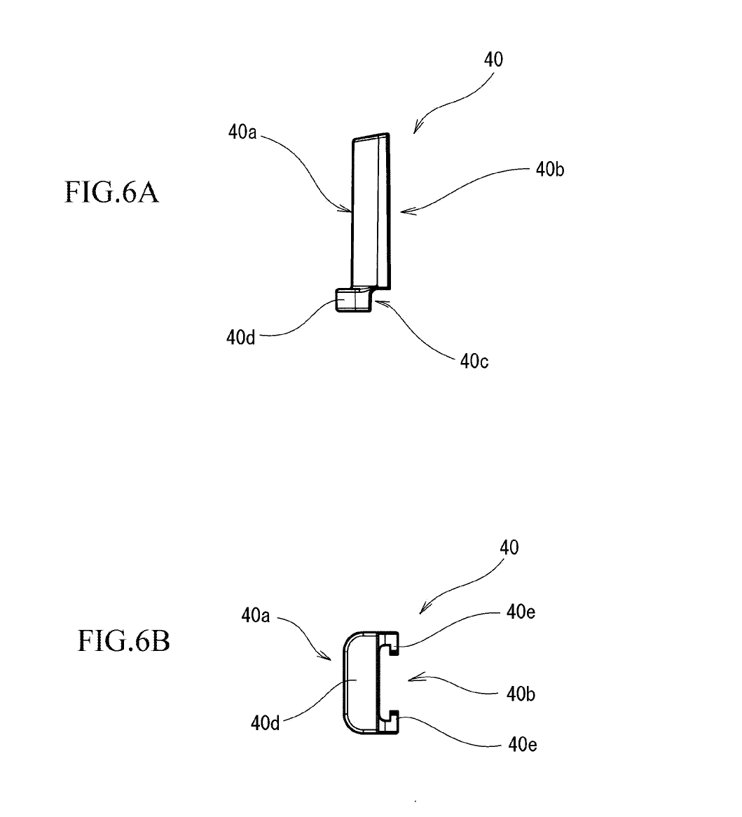

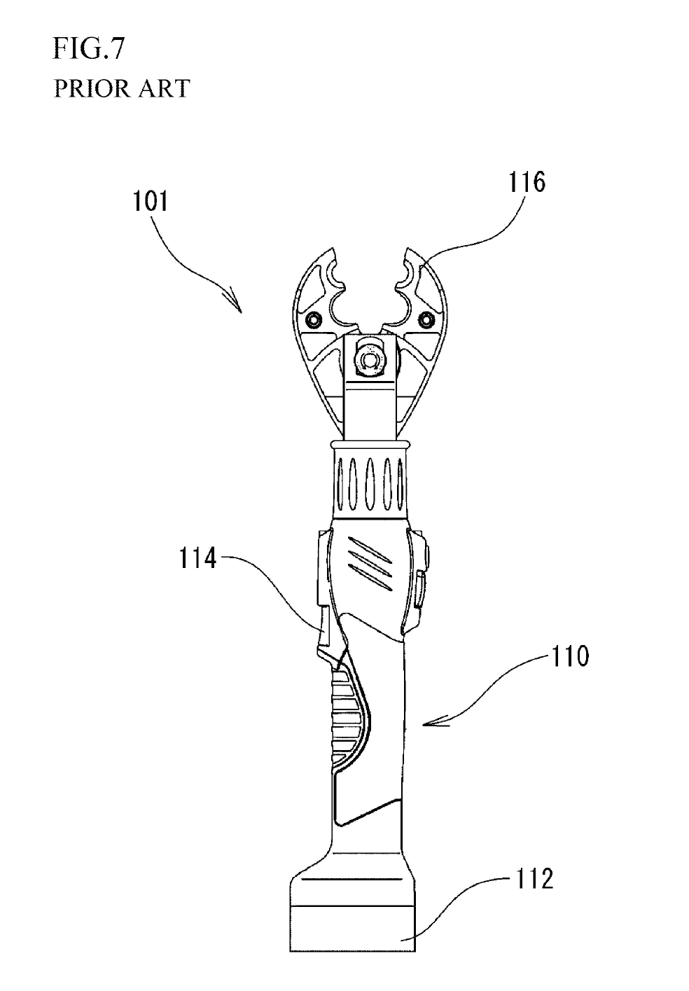

A configuration for allowing the lock plate 40 to slide will be described with reference to FIGS. 5A and 5B, and 6A and 6B. FIG. 5A is a drawing of the switch knob 30 viewed from a direction of a side surface, and FIG. 5B is a drawing of the switch knob 30 viewed from a direction of a rear end surface.

Correspondingly, FIG. 6A is a drawing of the lock plate 40 viewed from the direction of the side surface, and FIG. 6B is a drawing of the lock plate 40 viewed from the direction of the rear end surface. As an example, the switch knob 30 is provided with slide grooves 30e and 30e on the first surface 30a side. The lock plate 40 is provided with sliding projections 40e and 40e on a rear surface 40b side. In this configuration, the slide grooves 30e and 30e of the switch knob 30 engage the sliding projections 40e and 40e of the lock plate 40, and thus the lock plate 40 is allowed to slide in the direction indicated by an arrow B with respect to the switch knob 30, and the switch knob 30 becomes pivotable in the direction indicated by the arrow A in a state of being engaged with the lock plate 40 (see FIGS. 4A and 4B). In other words, when the operator presses the switch knob 30 to drive the electric tool 1, a front surface 40a of the lock plate 40 disposed on the plane of the first surface 30a of the switch knob 30 is pressed. As a modification, in contrast to the configuration described above, a configuration in which a sliding projection is provided on the switch knob 30 and a sliding groove are provided on the lock plate 40 (not illustrated) is also applicable.

In the configuration described above, by sliding the lock plate 40 to a first position, which is a position where the lock plate 40 is drawn out to the rear end portion, with respect to the switch knob 30, a predetermined portion of the lock plate 40 (here, an abutting portion 40c on the rear surface 40b side of the lock plate 40) is allowed to come into abutment with the projecting portion 11 (a distal end portion 11a here) of the body portion 10 when the switch knob 30 (the front surface 40a of the lock plate 40 here) is pressed, and a pressing movement is stopped at a position of abutment, whereby an effect of disabling the pressing movement is achieved (see FIG. 3A). In other words, since the pressing movement of the switch knob 30 can be restricted (locked), unintended driving can be prevented even when the operator or the object comes into contact with the switch knob 30 (the front surface 40a of the lock plate 40 here) during storage or transport.

In contrast, by sliding the lock plate 40 to a second position, which is a position where the lock plate 40 is pushed out to the distal end portion, with respect to the switch knob 30, a predetermined portion of the lock plate 40 (here, an abutting portion 40c on the rear surface 40b side of the lock plate 40) is brought into a state of not coming into abutment with the projecting portion 11 (a distal end portion 11a here) and any other portion of the body portion 10 when the switch knob 30 (the front surface 40a of the lock plate 40 here) is pressed, whereby the switch knob 30 is allowed to be pressed to a predetermined position (see FIG. 3B). Therefore, the power source can be turned ON to perform driving.

As an example, the height of the projecting portion 11 is set to have a clearance not larger than 3 mm with respect to the abutting portion 40c on the rear surface 40b side of the lock plate 40 with which the projecting portion 11 can come into abutment as a result′ of sliding movement. In other words, a clearance L between the distal end portion Ila of the projecting portion 11 and the abutting portion 40c on the rear surface 40b side of the lock plate 40 is not larger than 3 mm. In this configuration, when the lock plate 40 is slid to a first position with respect to the switch knob 30, the rear end portion of the lock plate 40 is prevented from hitting against the distal end portion 11a of the projecting portion 11 and a portion in the vicinity thereof and from becoming incapable of being pulled out, and simultaneously, a pressing distance of the lock plate 40 in the direction of the arrow A can be restricted to a distance which does not turn the power source ON. In the present embodiment, the clearance is set to an optimal value on the order of 1 mm.

The lock plate 40 is provided with a grip portion 40d projecting in a direction orthogonal to the direction of the sliding movement. Accordingly, when pulling the lock plate 40 to the first position, and when pressing the lock plate 40 to the second position, the operator is allowed to hook his or her finger on the grip portion 40d and easily achieves a sliding movement of the lock plate 40.

In the switch knob 30, portions other than the portion where the lock plate 40 engages are preferably configured to have the same shape as the switch knob used in the electric tool of the related art disclosed in JP-A-2013-169573, for example. In this configuration, in the electric tool of the related art, only the switch knob can be replaced by the switch knob 30 of the present embodiment. In this manner, with the compatible configuration, probability that users of the tools of the related art can enjoy an effect of the invention is increased.

As described thus far, according to the electric tool of the invention, a state in which the pressing movement of the switch knob is restricted (locked) is achieved by causing the lock plate to slide to a predetermined position (the first position where locking is enabled). Accordingly, even though the operator or the object comes into touch unintentionally with the switch knob when storage or transport is performed in the state in which the battery is mounted on the body portion, the switch knob may be kept in a state of not being pressed. Therefore, unintentional driving can be prevented from being performed.

The invention is not limited to the embodiment described above and may be modified variously without departing the scope of the invention. In particular, although the crimp tool has been exemplified as the electric tool of the invention, the invention is not limited thereto, and may be applied desirably to a cutting tool or the like.

1. An electric tool configured to be driven by electricity comprising:
a switch knob configured to turn a driving power source ON by being pressed, wherein
the switch knob is provided with a lock plate fixed so as to be slidable between a first position at which the lock plate comes into abutment with a predetermined portion of a body portion of the electric tool and a second position at which the lock plate does not coming into abutment with the body portion when the switch knob is pressed.

2. The electric tool according to claim 1, wherein the switch knob is fixed at other end side thereof to the body portion by being axially supported by the body portion so as to be pivotable at one end side in an arcuate shape, and the lock plate is provided on a plane of a first surface orthogonal to the direction of the pivotal movement.

3. The electric tool according to claim 2, wherein the predetermined portion of the body portion is a projecting portion formed on the body portion so as to extend upright along an end surface of the one end side of the switch knob, and
a clearance between an abutting portion of the lock plate which allows abutment of the lock plate by the sliding movement and a distal end portion of the projecting portion is set to be not larger than 3 mm.

4. The electric tool according to claim 1, wherein the lock plate is provided with a grip portion projecting in a direction orthogonal to the direction of the sliding movement.

5. The electric tool according to claim 2, wherein the lock plate is provided with a grip portion projecting in a direction orthogonal to the direction of the sliding movement.

6. The electric tool according to claim 3, wherein the lock plate is provided with a grip portion projecting in a direction orthogonal to the direction of the sliding movement.

7. The electric tool according to claim 1, wherein a sliding groove is provided on one of the switch knob and the lock plate, and a sliding projection is provided on the other one of the switch knob and the lock plate, and the sliding groove and the sliding projection engage each other.

8. The electric tool according to claim 2, wherein a sliding groove is provided on one of the switch knob and the lock plate, and a sliding projection is provided on the other one of the switch knob and the lock plate, and the sliding groove and the sliding projection engage each other.

9. The electric tool according to claim 3, wherein a sliding groove is provided on one of the switch knob and the lock plate, and a sliding projection is provided on the other one of the switch knob and the lock plate, and the sliding groove and the sliding projection engage each other.

10. The electric tool according to claim 4, wherein a sliding groove is provided on one of the switch knob and the lock plate, and a sliding projection is provided on the other one of the switch knob and the lock plate, and the sliding groove and the sliding projection engage each other.

11. The electric tool according to claim 5, wherein a sliding groove is provided on one of the switch knob and the lock plate, and a sliding projection is provided on the other one of the switch knob and the lock plate, and the sliding groove and the sliding projection engage each other.

12. The electric tool according to claim 6, wherein a sliding groove is provided on one of the switch knob and the lock plate, and a sliding projection is provided on the other one of the switch knob and the lock plate, and the sliding groove and the sliding projection engage each other.
